(19) United States
(12) Patent Application Publication
(10) Pub. No.: US 2014/0209598 A1
(43) Pub. Date: Jul. 31, 2014

(54) Cooking Pot with a Heated Lateral Wall and Process

(71) Applicant: Jocelyn Bonnel, Vions (FR)

(72) Inventor: Jocelyn Bonnel, Vions (FR)

(73) Assignee: SEB S.A., Ecully (FR)

(21) Appl. No.: 14/232,485

(22) PCT Filed: Jul. 11, 2012
(86) PCT No.: PCT/FR2012/051637

§ 371 Date: Mar. 19, 2014

(30) Foreign Application Priority Data
Jul. 13, 2011 (FR) 1156376

(51) Int. Cl. A47J 27/00; H05B 6/12; H05B 3/06

(52) U.S. Cl. CPC A47J 27/004; H05B 3/06; H05B 6/12
USPC 219/621; 219/438; 219/387; 29/611; 29/606

(57) ABSTRACT

Provided is a kitchenware item comprising a pot comprising a metal substrate (31), and a power supply source (7) connected to a heating electrical resistance (9) with which the pot is provided. The electrical resistance is arranged in the region of the side wall (300) of the pot: either outside the metal substrate, or embedded in said substrate, within either a moulded electroconductive metal material or a plurality of electroconductive metal layers that are interconnected, without adhesive, by deformation and/or physicochemical metal connection.

The invention concerns a cooking pot to be used as a container to cook or, more generally, to heat food.

Such an pot is already known, including:
a pot designed to receive food which includes a substrate with a bottom and a side wall creating a border around the bottom, and an heating electrical resistance located near the pot's side wall,
an electrical power source (to produce electricity) is connected to the electrical resistance to provide electrical power. Accordingly, the electrical power source is not the electricity grid; it is incorporated into the pot.

JP-A-2008142205 discloses cooking pot 2 with handle 3 including battery 10 which powers heating resistance in the thicker bottom of the pot (the reference numbers are those used in this document). The general principle of a cooking pot with a handle including an energy source which provides electrical power to a mechanism outside the handle is, therefore, known.

However, the goal of JP-A-2008142205 is to provide a solution to allow the cooking pot to be used autonomously or as a service plate, not at all to be used to cook or, more generally, as a heat source such as: an electrical plate, flame from a gas source or an induction coil for induction heating of the bowl. The solution is a hand-held portable device, which is relatively light and which apparently is easy to use and operates thermally.

Despite everything, one problem remains with respect to, in particular, thermal performance, above all if the targeted application is not particularly independent use, as is the case below. The goals targeted here include, in particular, indoor use, near an available heat source to:
limit the thermal losses of the bowl when it is heated, and/or
obtain (or, at a minimum, enhance) even heating in this bowl, and/or
improve the provision of continuous heat to the food to cook it, in particular, when using a cover.

One solution proposed is that the first pot described above have a substrate in its bowl made of at least one metallic layer, and that the heating electrical resistance be:
located outside the metallic substrate, or
incorporated into said substrate, within:
   either an electrically conductive metallic material, which is milled, or
   several electrically conductive metallic layers, without adhesive, interconnected by deformation and/or chemical-physical metallic bond.

The terms:
“without adhesive” means excluding any glue adhesive,
“outside the metallic substrate” means “on the surface”, attached to it, against it or separated from it by a thin layer, typically an electrical insulation layer,
“metallic bond” means a chemical bond which allows atomic cohesion of one or more metals placed in contact with one another(e.g., brazing, or even colaminating),
“layers interconnected by deformation” means different metals interconnected by soldering without fusion using plastic contact metal deformation (e.g., by impact pressure, in particular, when cold) and/or matter diffusion (as in a colaminating); see, http://halensmp.archives-open.fr/docs/00/57/05/47/PDF/Kaabi-Bien-venu-Ryckelynck_MatA_riaux_{—}2010_{—}5_p.pdf.

Therefore, the radiating effect is reduced, replaced, in whole or in part, with:
even temperature across the side wall,
possibly, an increase in heating speed,
a heat safety position, once cooking has been completed.

In addition, it should be possible to reduce the thickness of the materials, or even select materials which are less apt to thermal distribution (stainless steel instead of aluminum, for example, while obtaining the same thermal distribution effectiveness throughout the pot), while ensuring identical, clean cooking, in particular, by limiting the thermal gradient between the bottom and the side wall, which may also increase the durability of the anti-stick coating which typically covers the internal face of the metallic layer of the bowl and often (such as with PTFE) is sensitive to very high temperatures (more than 300° C., or even 250° C.).

It will also be possible, at least when the beginning of manufacturing, to differentiate the foregoing bowls (with this electrical resistance) from those which do not have it. In this regard, the bowl in JP-A-2008142205 has the disadvantage that the electrical resistance is located in the middle of the metallic bottom wall.

To function advantageously when intense heat is used, regardless of the location (within the wall or on the surface) of the resistance, it is also advisable that the bottom of the bowl, the lower surface of which is securely placed facing an external heat source which includes one of the following: an electrical plate, flame from a gas source, or induction coil for induction heating of the pot, be designed to resist heat from said external heat source, and therefore include:
a multilayered substrate structure (with, for mechanical and thermal reasons, at least three such layers which may be different metals or metal alloys),
and/or at least:
   a stiffening stamp, or
   a magnetizable metal insert (for example, ferromagnetic) which is attached to a malleable metallic layer of the substrate and/or which is harder than this malleable layer (on the lower surface side).

Accordingly, thermal and mechanical performance are combined, with good durability, regardless of the external heat source used from among those listed above, which can be further improved if the electrical resistance is located solely near the pot's side wall. In effect, the issues related to bottom deformation can be eliminated from those listed above on page 2 by optimizing each.

Among the possible pots (also called bowls) recommended here, therefore, it is possible to envision a bottom which is strengthened and/or suitable for induction heating. This pot with an integrated bottom and side wall made of the same metallic material (for example, aluminum) is preferably bonded with a metallic layer (such as aluminum) on the outside of the bottom which is more malleable than that making a lower dish made, for example, from ferrous steel, which is magnetizable, or ferromagnetic, covering said more malleable metallic layer. Heat forging (to create the multilayer bottom) along with stamping (to create the side wall) may then be particularly appropriate as a manufacturing technique.

However, to increase the ease of manufacturing and any maintenance on the pot, everything notwithstanding, it is recommended that the internal surface of the lateral wall be oriented to the interior recess of the substrate and a facing outside surface and that the heating electrical resistance be a deposited near the outside surface of the side wall; the electrical insulation layer will itself be a deposit attached to the metallic substrate.

To enable rapid manufacture and create a durable pot, it is further recommended that the electrical resistance, in particular if located on the surface and not incorporated into the substrate, rather than including wires individually coated with protective electrical insulation, be interposed between a flat electrical insulation layer scope placed against (one of the) metallic(s) layer(s) of the substrate and a coating layer for mechanical and/or chemical-physical protection.

If the electrical resistance is incorporated into the metallic substrate, it is preferred that it be located solely near the pot's side wall and that it be surrounded, at that location, with a layer of electrical insulation separating it from said metallic material or said metallic layers which surround it as this material or these metallic layers are preferably electrically conductive.

In this way, reliability, achieving the expected lateral heat and compliance with the desired manufacturing speeds and conditions, including in terms of controlling bottom deformation over time, are combined. If it is incorporated into the substrate, even individually insulated wires are preferred.

Preferably, the electrical power source of the resistance, which, therefore, equips the bowl's side wall, will be provided on a handle attached to the pot to raise it and allow the pot to be held by hand. Accordingly, it is possible to take advantage of the space which is usually empty in a handle while maintaining minimum dimensions for a functional grip.

To make use even easier and the pot more compact compared to JP-A-2008142205, it is also recommended that:
the handle be attached to, and be removable from, the pot using an attachment mechanism which can be separated (for example, the electrical source may then be used to move the removable fixation mechanism heretofore provided on the handle), and
this electrical resistance and handle have primary and secondary electrical contact terminals which come into contact with one another when the handle and pot are attached (serious risk of contact due to the fact that the handle is placed laterally as opposed to, for example, a cover which is placed from above).

In addition, and preferably, the electrical resistance extends at least most of the way around the pot's side wall and/or along its height.

The fact that the heating electrical resistance extends along the surface around most of the edge of the side wall, and not on (in) the bottom as in JP-A-2008142205 where only two wires lead to a specific location in the middle of this wall, is an advantage here since it is possible to select a location with greater flexibility to connect where the electrical power source connects to power the resistance, both in terms of radial position and it terms of its height for a handle.

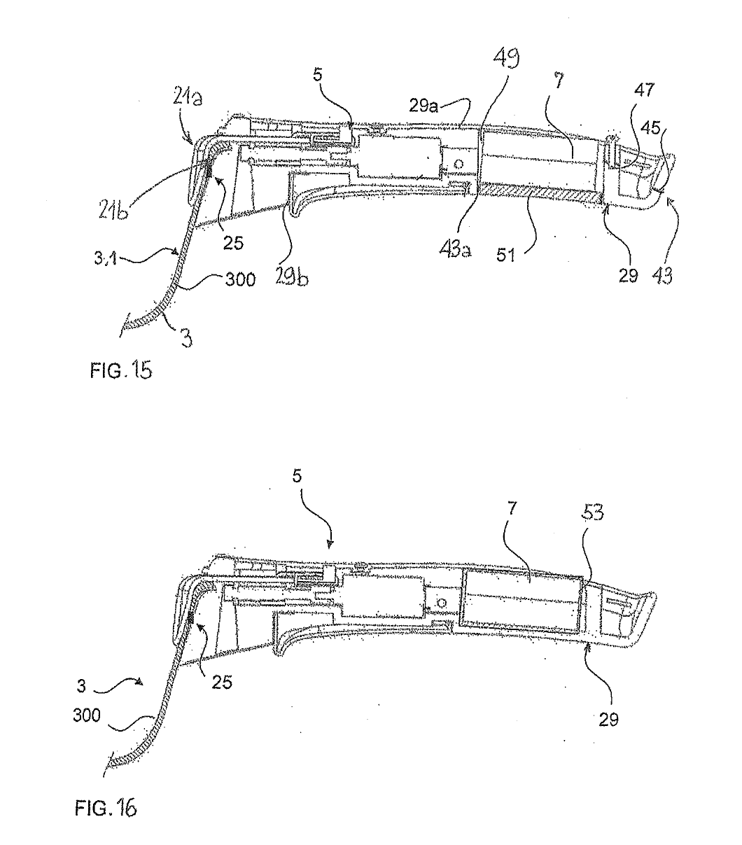

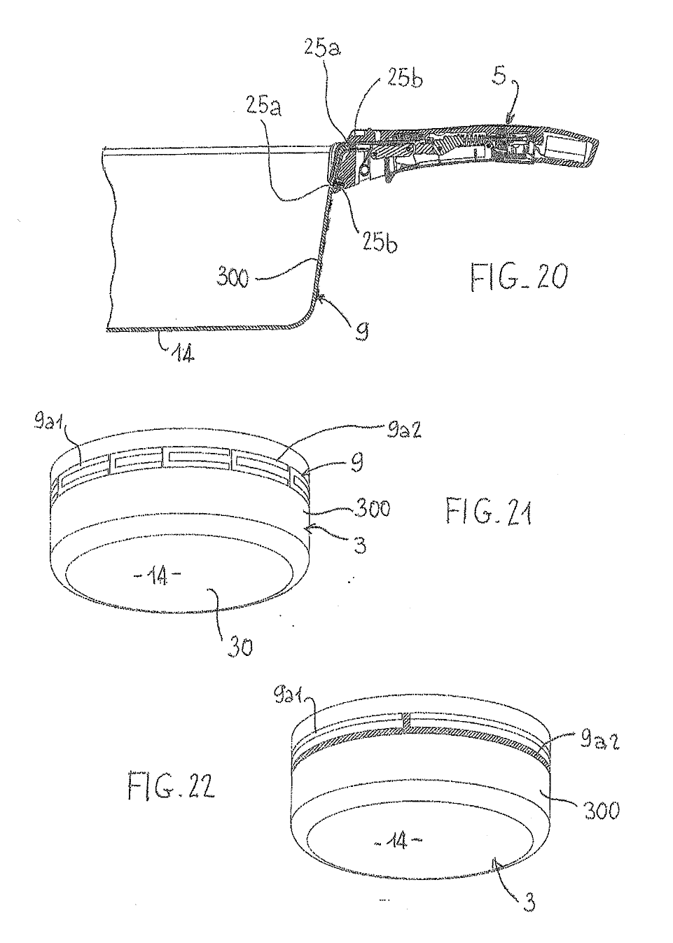

Another positive aspect will be generated if, when the handle is attached, its attachment mechanism is in contact with both the internal face (food side) and with the outside of the bowl's side wall, achieving in a single attachment both an easy electrical connection of the handle, whether the contact terminals (or zones) provided for this purpose are localized (FIGS. 1, 15) or not (FIG. 20).

This is even more important if the pot/handle attachment mechanism includes two bits which form a pincer by moving with respect to one another to attach the handle to the pot, wherein said secondary electrical contact terminals are located on (at least) one of these bits.

In one important implementation of this type, the attachment mechanism also includes, on the handle, the bits of a pincer and, on the bowl, a section of the side wall near its upper outside edge so that the bit will more directly pinch, from above, one of these bits which, therefore, is equipped with said secondary electrical contact terminals.

For electrical performance which permits high-quality cooking, in particular, with a frying pan which can be used to sear meat, it is recommended that the electrical contact terminals of the electrical power source of the resistance be retracted by an elastic recall mechanism and limit the contact resistance with the pot's terminals to less than 100 mOmhs, and preferably to less than 10 mOmhs.

For high quality electrical contacts, it is recommended that:
said elastic recall mechanism on the secondary electrical contact terminals be used with terminals which protrude and that the initial contact terminals be recessed terminals, or
identification means be provided on the electrical source and on the bowl to pair them with respect to one another when attaching the primary to the secondary.

Again for electrical performance, it is recommended that each electrical contact terminal have a cross-section of at least 0.75 mm² to resist 8 to 14 A of current.

To allow the pot to be used as a service plate, or far from a socket connected to the electricity grid, it is recommended that, if a handle is used, it consist of a hollow body and that the electrical power source with which it is equipped consist of a rechargeable electrical energy source, such as a battery, housed in said body and connected to one of the recharging terminals in the body, the handle being then equipped with watertightness means which protect said rechargeable electrical energy source from humidity.

Accordingly, if the handle is removable, it can be, if necessary, cleaned with water (even immersed in water), even though it is an “electric handle”.

The invention also covers a procedure to manufacture a cooking pot with all or part of the foregoing characteristics. Details are provided below.

Other characteristics and benefits of the invention may emerge from the description below, with reference to the drawings attached as an example. In these drawings:

FIG. 1 shows a vertical cut-away of a cooking pot to cook food and shows the interior of a useable handle;

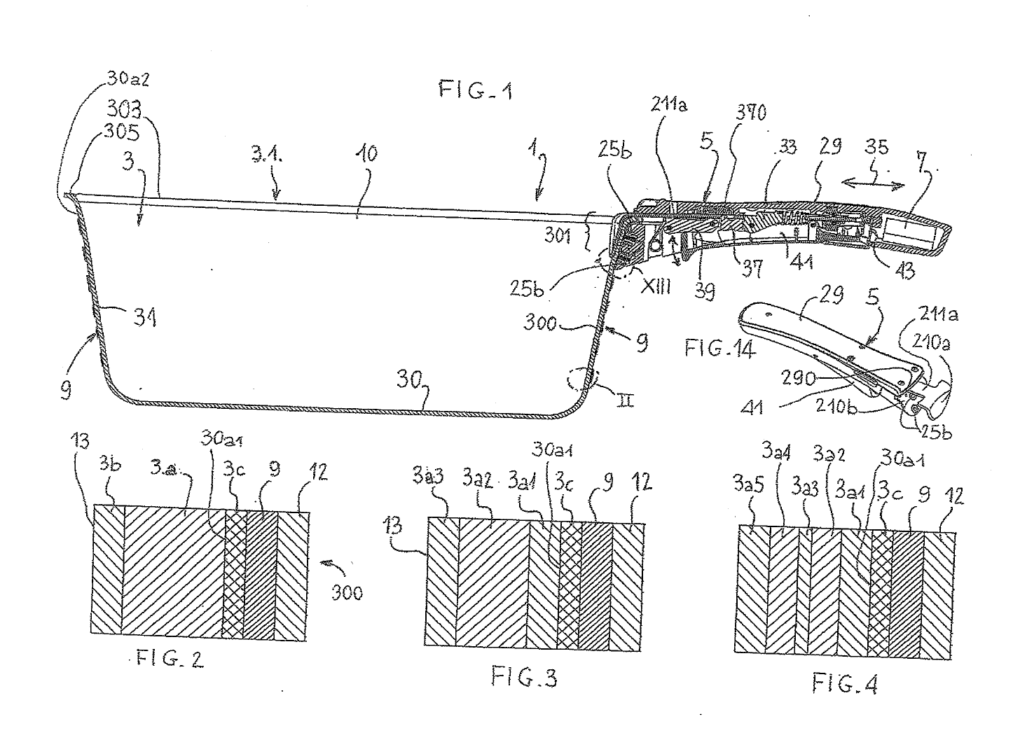

FIGS. 2, 3, and 4 are expanded views of the layers of which the bowl may be formed at the location where there is a heat resistance; FIG. 2 is expanded view II of FIG. 1,

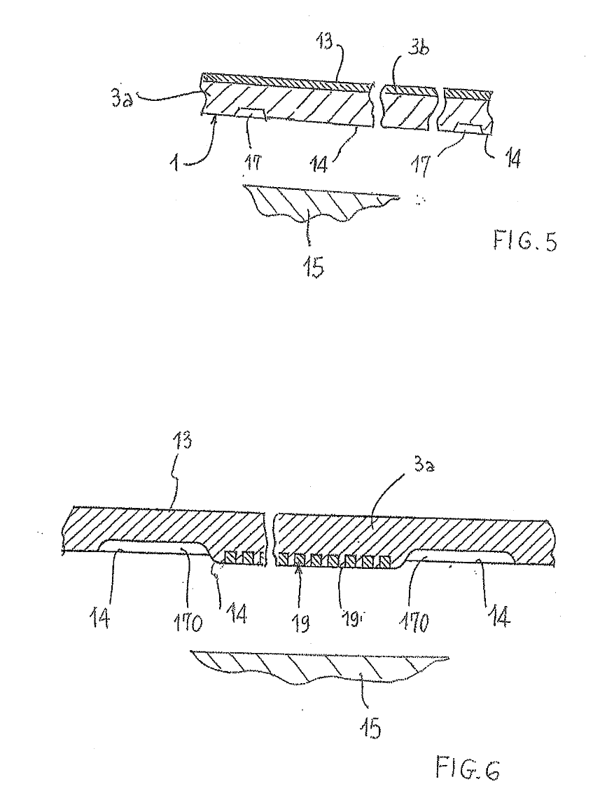

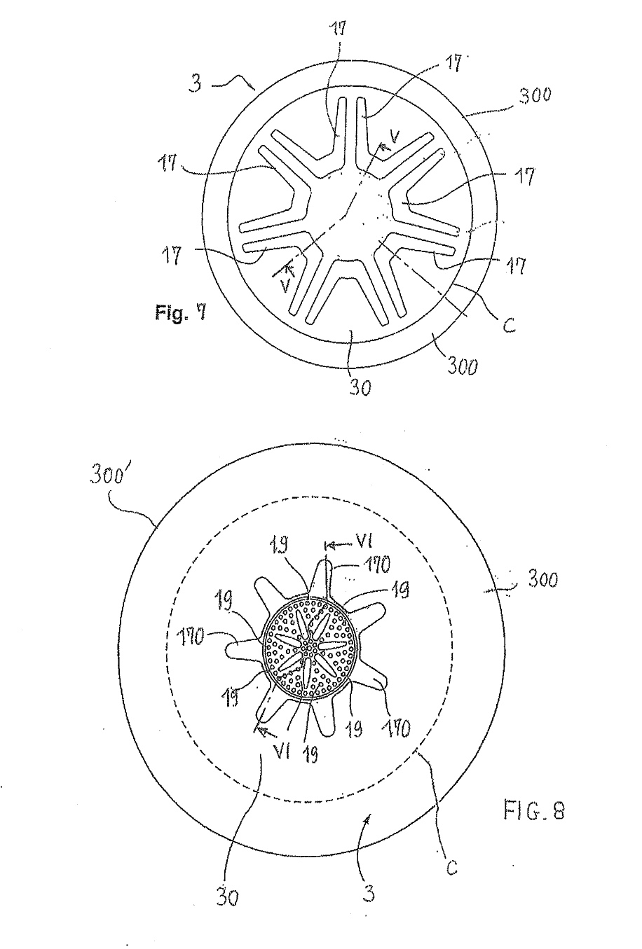

FIGS. 5 and 6 correspond to cut-aways V-V and VI-VI of FIGS. 7 and 8, respectively, which each show a view from below of a mechanically strengthened bottom, and

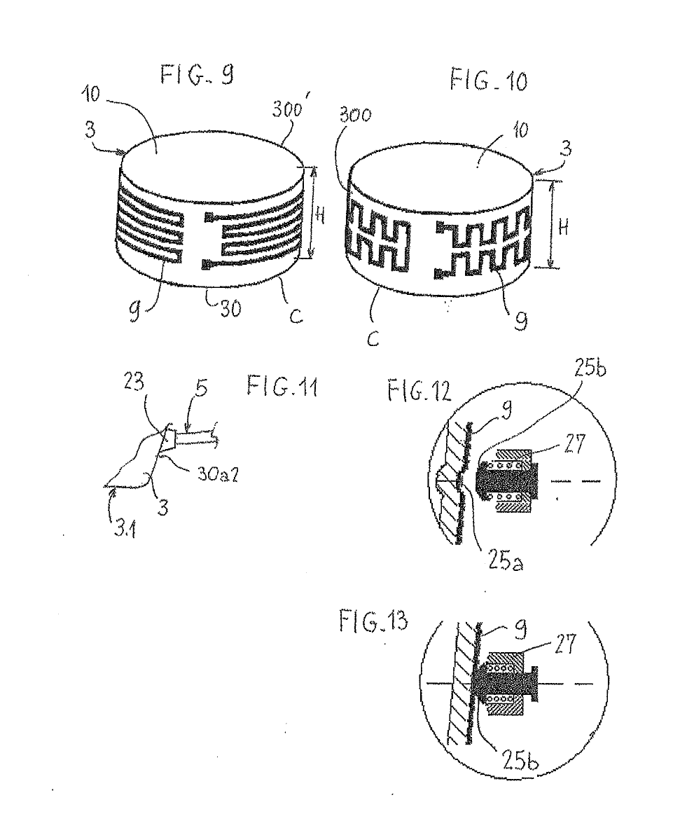

FIGS. 9 and 10 show two examples of electrical resistance types,

FIG. 11 shows the handle attached to the bowl using a base;

FIGS. 12 and 13 show a possible implementation of the interaction between the terminals of the handle and pot, in a “removable handle” solution,

FIG. 14 shows an outside view of the single handle in FIG. 1, with the bits opened,

FIGS. 15 and 16 show removable handles with a cover and watertightness joint with a rechargeable energy source incorporated into the material which forms the grip body, respectively;

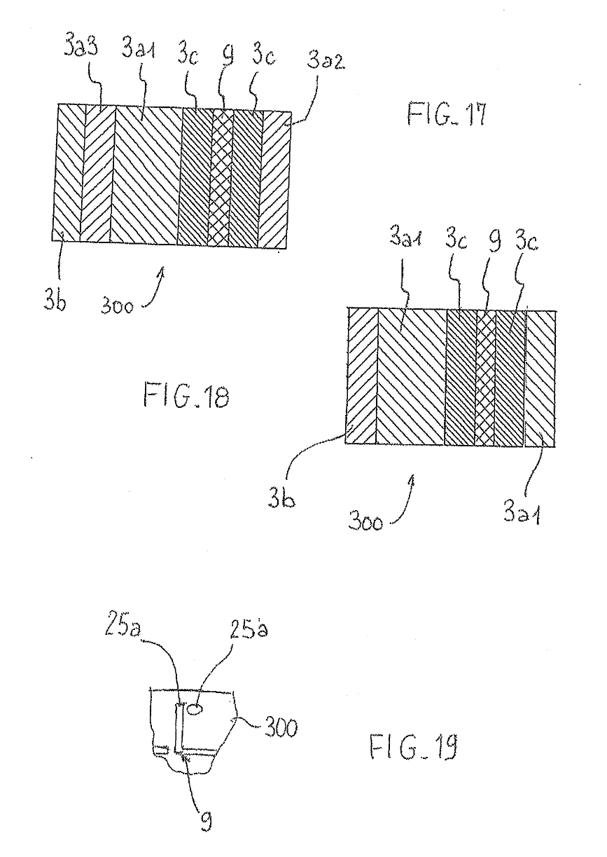

FIGS. 17 and 18 are each an alternative (both cutaway views) to the drawings in FIGS. 2-4;

FIG. 19 is a close up view from above of a bowl with an electrical circuit built into the substrate,

FIG. 20 is a solution where electrical energy passes through the metallic substrate of the bowl,

FIGS. 21 and 22 show two examples where, to create the electrical contact between the pot and handle, the angled position of the handle around the pot is not important. There is no predetermined position because of the location selected for the contact terminals between the pot and handle. In addition, these illustrations show two cases where a resistance is formed by multiple resistances; in the first case, the resistances are independent; in the second, they are interconnected,

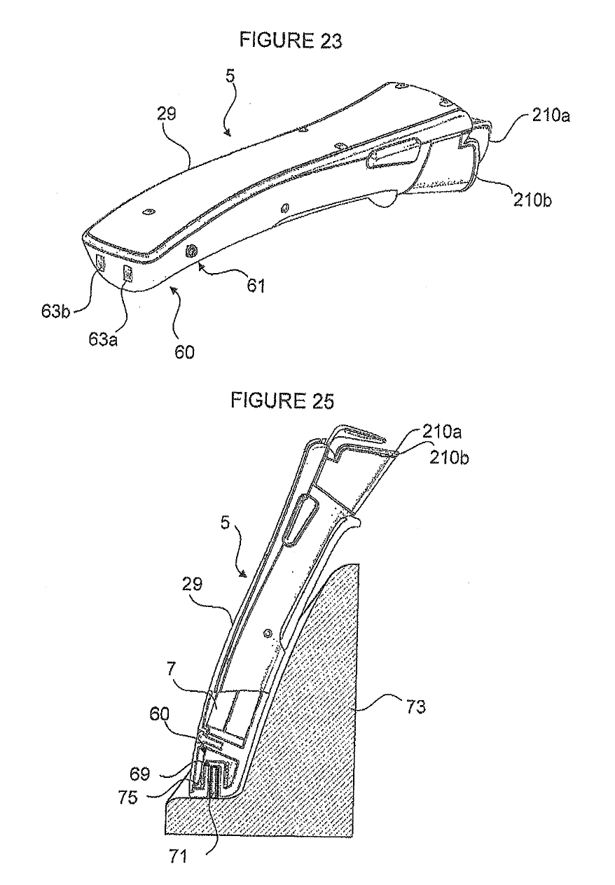

FIGS. 23, 24 and 25 are illustrations of the connection between the power source recharging unit on the cooking utensil in question, which is ancillary to the pot.

Below and throughout the text and illustrations, these variations should be considered combined in whole or in part.

FIGS. 1 and 2, in particular, therefore, show cooking pot 1. It includes:
bowl 3 formed using a metallic substrate with at least one metallic layer 3a designed to hold food, and
as an example of a relating cooking utensil, handle 5 is attached to the bowl to raise it and thereby allow the pot to be held by hand.

The cooking utensil selected can be useful for this pot (lighting, blending, carrying means, etc.). It has, in and of itself, a purpose other than (solely) electrical or induction heating of the pot. Preferably, it will be a cooking utensil that may be held by hand. Then it can be, inter alia, moved and/or held to operate it or carried and/or to carry the pot using it. A handle is, therefore, a good example.

Handle 5 is equipped with electrical power source (production) 7 connected to heating electrical resistance 9 with which the bowl is equipped to provide electrical power for this resistance.

The bowl has bottom 30 and lateral wall 300 which angles upward from the bottom edge until upper opening 10.

Electrical resistance 9 is located near the side wall, on the outside surface of the metallic layer(s) of the substrate. It is a pathway or wire.

In FIG. 2, the metallic substrate includes single metallic layer 3a (aluminum or stainless steel, in particular). In the interior, this substrate is covered with anti-stick coating 3b, for example, or a PTFE base. Here, on the external face, metallic layer 3a is coated with electrical insulation layer 3c. This layer 3c is preferably attached by depositing. It preferably has a thickness of at least 20 to 50 microns to be effective given the electrical requirements of resistance 9, which is attached to insulation layer 3c, on the outside.

Electrical resistance 9 is preferably added by depositing around the metallic substrate, here against insulation layer 3c. Accordingly, it will be attached while being placed, in this case, therefore, by depositing.

Resistance 9 may be a metallic pathway the wires of which are not sheathed by electrical insulation.

This metallic pathway may be attached by thermal projection. For chemical-physical protection, it is recommended during coating on the outside that this resistance be coated by protective coating 12, which is recommended as protection against oxidation. Electrical insulation coating 12 is preferred.

Resistance 9 could also be polymer based which, when deposited, should be protected mechanically by protective coating 12.

Other alternative: resistance 9 may have an enamel base containing conductive pots. Then it will not be absolutely necessary to use mechanical protective coating 12 and/or a chemical-physical coating to attach it because it will already be attached to the bowl during deposit around resistance 9.

FIGS. 3 and 4 show the metallic substrate with multiple metallic layers (metal or metal alloys), 3a1, 3a2, 3a3, 3a1, 3a2, 3a3, 3a4, and 3a5, respectively.

Layers 3a1, 3a2, and 3a3: for example stainless steel/aluminum/stainless steel; layers 3a1, 3a2, 3a3, 3a4, and 3a5: for example, stainless steel/aluminum/stainless steel (or copper)/aluminum/stainless steel.

Colaminated layers are recommended.

On the outside, again resistance 9 is attached to the substrate in question, with electrical insulation layer 3c and possibly external protective coating 12 interposed. Interior anti-stick deposit 3b is not required on stainless steel.

On bottom 30, there is a substrate and, if necessary, this interior anti-stick coating 3b, here without layers 3c and 9; therefore, without coating 12.

In FIGS. 2 and 5, the bowl includes single metallic layer 3a (for example, steel). If it is made of aluminum and induction heating is desired, the bowl substrate must include at least one other layer or an insert made of a magnetic metal. Interior coating 13 is possible, as in FIG. 5.

FIGS. 5 and 6 show that each bottom 30 has lower surface 14 to be placed facing external heat source 15 and an face upper 13 to hold the food.

Source 15 is one of an electrical plate, flame from a gas source or an induction coil for induction heating of the bowl, as in FIG. 6 where, for heating, the bottom arches slightly so that surface 14 is eventually at 150-200° C. and, in particular, FIG. 5 or 6, flat or slightly concave upward.

Lower surface 14, and, in general, each bottom 30 is designed to resist heat from the external heat source in question.

As shown in these FIGS. 5 and 6, respectively, supplemented by FIGS. 7 and 8, for that purpose lower surface 14 here includes at least one stiffening stamp 17 or insert 19 made from a stronger metal (for example, steel) than that of layer 3a (for example, aluminum) of which lower surface 14 is made and which is attached to this layer and is a part of it.

Stamp 17 is free of material. It does not go outside the metallic layer in which it is formed. The same may apply to stamp(s) 170 which may exist in addition to an insert made of harder metal as in FIGS. 6 and 8 where this insert is stamped (from below) on a section of the substrate thickness, here the metal in layer 3a. The insert may be a perforated plate which is easy to attach, as explained, by stamping.

Yet another mechanical resistance solution over time for bottom 30 is also, therefore, that corresponding to FIG. 4 where the five layers 3a1, 3a2, 3a3, 3a4, and 3a5, here, stainless steel/aluminum/stainless steel (or copper)/aluminum/stainless steel, provides the desired effect without an insert or stamp. Idem for a triple layers 3a1, 3a2, and 3a3: stainless steel/aluminum/stainless steel.

Even if the substrate is not placed on the interior side (concave surface), electrical resistance 9 should be configured, for manufacturing performance (broader choice of the type of resistance, reliability in bowl manufacture) as substrate is arranged on exterior side 30a1 at side wall 300.

As shown in FIGS. 9 and 10, it is recommended that this electrical resistance 9, which can have several shapes, extend at least most of the way around (perimeter) and up to height H of side wall 300; this height H is defined as between upper outside edge 303 and bottom 30 which is generally (deemed to be) horizontal and flat (even if in reality this bottom is slightly convex upward to create additional mechanical resistance to repeated deformations caused by heating). Line C in FIGS. 7 and 8 marks the conceptual border between 30 and 300.

Electrical resistance 9 shows isographic lines of similar heating.

FIGS. 1 and 15 show that handle 5 may be attached to and removed from pot 3.1 to which bowl 3 belongs using attachment mechanism 21a and 21b, which can be separated from one another.

These primary and secondary attachment mechanisms 21a and 21b may be located respectively on the handle and on base 23 mounted on the outside of the bowl and attached to it, against its outside surface 30a2 attached, for example, by screws; see FIG. 11 in this case, and as in DE-102007054022 A1, primary and secondary attachment mechanism 21a and 21b may create a system of defined curved slides on the handle and the base built around means 4, 8, and 11 described in this document. It is also appropriate to place mechanism 21a and 21b on the handle and bowl 3.

Handle 5 is equipped with secondary terminals 25b which come into contact with initial terminals 25a on electrical resistance 9 so that an electrical contact which can be broken is created when the handle and the bowl are both attached; see FIGS. 1, 12, and 13.

It is recommended that resistance 9 then extend at least most of the way around (perimeter) of side wall 300 and/or its height H.

In the example in FIGS. 1 and 14, primary and secondary attachment mechanism 21a and 21b include, respectively, on the handle, bits 210a and 210b of a pincer and, on the bowl, section 301 of its lateral wall, immediately adjacent to its upper outside edge 303 the entire circumference of which is exterior edge 305.

Bits 210a and 210b pinch section 301 from above. One of these bits (preferably only one; stationary bit 210b) is equipped with secondary electrical contact terminals 25b.

Although it would be worthwhile to have such a pincer with a mobile bit moving in translation (see for example, EP-1991098 for more details on how to ensure this movement), the bit could, inter alia, move otherwise, and the attachment on the base could also create the electrical contact between the handle and pot. Then, initial terminals 25a would be mounted on this base to make contact with secondary terminals 25b when clamping occurs.

To move mobile bit 210a with respect to fixed bit 210a opposite it, slide 33 mounted in translation in longitudinal direction 35 compared to body 29, and primary and secondary pivoting connecting rods 37 and 39 from FIG. 1 are used. The secondary connecting rod acts directly on mobile bit 210a. Maneuver button 41 mounted to shift on body 29 controls secondary connecting rod 39d and, thereby, articulated chain 33, 37, and 39, via lug 370 through a opening in rod 211a which ends with bit 210a. Additional details are available in EP 2007260. Body 29 is shaped to allow a hand to grip the handle and is hollow. Inside electrical connection 43, for example, a wire connects electrical source 7 and terminal(s) 25h.

With respect to primary and secondary terminals 25a and 25b, FIG. 12 shows that they will be preferably and respectively hollow (concave) and protruding (convex), thereby creating correct positioning 5 between them (FIG. 13 diagrams a flat connection, which is also possible).

It is further recommended that elastic recall mechanism 27 (such as springs) be provided for on (behind) the secondary contact terminal(s) to naturally push them toward the primary terminal(s). in FIG. 12, terminal 25b is in the rest position, pushed toward (but remaining separate from) the pot by the spring or equivalent mechanism; in FIG. 13, elastic mechanism 27 is under tension and pulls terminal 25b into contact with resistance 9.

It is further recommended that:
these terminals 25b limit, with contacts 25a of the pot, contact resistance to 100 mOmhs and preferably to 10 mOmhs,
each terminal 25a and 25b has a cross section of at least 0.75 mm² to resist a current of 8 to 14 A.

In the case of removable handle 5, two contact terminals may advantageously be place on forward extremity 290 of grip body 29 of the handle (FIG. 14); in particular, a minimum cross section of 0.75 mm² capable of resisting current on the order of 10 A could be mounted on the spring to limit contact resistance to 100 mOmhs and preferably 10 mOmhs.

In the case of a handle attached to the pot, therefore without terminal 25a and 25h, the wires coming from electrical power source 7 may be directly soldered to heating pathway 9 and the connector may be housed in the aforementioned attachment base 23.

With a 12V energy source, it is possible to heat a resistance of 0.3-1 Ohm at 60-100 W, which is appropriate for the stated purposes, but not for cooking food (by heating bottom 3 using a primary heat source: gas, electrical or induction) but by limiting thermal losses (radiation effect from the side wall) and even heating of the bowl.

The effective power to be provided depends on the type of pot and recipe; for example:
significant short-term power for quick heating (5-15 min): heating water, soup, etc., 80-90 W,
less power, for example, 40-50W for long term cooking (more than 30 min., or even several hours, for simmering).

For a 20 cm-diameter casserole, convection losses from the side wall of a standard pot (for example, a frying pan) are 44 W (10 W/m².° C.). For an emissive surface (example, a PTFE coating with an emission level of 0.95) heated to 100° C., radiation losses are estimated to be 36 W.

With heating resistance 9 of 80 W (without loss to the exterior, as favorably shown in FIGS. 17 and 18, or in FIG. 2-4 with thermal insulation coating 12) these losses are offset; if resistance 9 returns 80 W of power (still without loss to the exterior) side wall 300 is heated.

In all cases, the radiation effect is reduced. To do so, it is clear that, when resistance pathway 9 is powered with electricity, it heats and transmits heat to side wall 300 on which it is mounted, and which is therefore no longer heated only by conduction of the heat also transmitted to bottom 30 (gas, electrical or induction source), which, therefore, has no electrical resistance (see FIGS. 1, 5-8, 20-22).

In FIG. 1 in particular, power/electrical production means 7 is a battery. It is housed in hollow body 29 of the handle. In this case, said means 7 is a rechargeable energy source (a battery). To ease the recharging of (or even, theoretically, to replace) this energy source 7 and clean the handle, it is recommended that the handle be equipped with watertightness means 43.

Watertightness means 43, which make electrical energy source 7 watertight against humidity, or even liquids, may be applied to grip body 29. It may include joint 45 located between the (two) shells 29a and 29b which collectively create body 29 which are tightened together by screws 47; see FIG. 15. Further, housing 49 of body 29 which receives source 7 is watertight. It is closed by cover 51. The watertightness means includes joint 43a located between cover 51 and the external peripheral edge surrounding housing 49. Joint 43a may be a flat joint.

In another possible implementation shown in FIG. 16, electrical energy source 7 is contained by coating 53 to form grip body 29 when it is cast.

FIGS. 15 and 16 also show that electrical contacts 25 between the pot and the item containing source 7 could be horizontal.

With respect to the manufacture of such a cooking pot, and in particular bowl 3 if it is designed based on one of the scenarios in FIGS. 2-4, the following is recommended:
a recessed shape is placed on the substrate so that it then creates bottom 30 and side wall 300 on the periphery of the bottom, and
prior to or after this stage when the recess is created, heating electrical resistance 9 is attached near side wall 300, outside the bowl, preferably on external periphery 30a1 of metallic layer(s) 3a1, 3a2, 3a3, 3a4, and 3a5 of this side wall.

This allows the technique for placing resistance 9, its form and its dimensions, to be easily selected without interference with deposited coating 3b or surface 13 which must be uniform. Heating pathway 9 may, in particular, be placed by silk-screening, pad printing, decaling, or thermal projection.

However, it is recommended that this resistance be attached to the pot by depositing. It is even recommended that the resistance be obtained by the depositing of silkscreened pathways with at least one electrically conductive material. The expected effectiveness and reliability will be all the better achieved.

In addition, with respect to this resistance 9 as already indicated, it will be then connected to electric power source 7 with which the cooking pot is equipped.

The bowl may be created by, inter alia, stamping, flow forming, tempering, and casting, in particular, hot stamping.

To incorporate resistance 9, cold or hot stamping, colaminating with multiple metallic layers, or even casting or brazing may be used. If colaminating is used, insulation 3c may not fully surround resistance 9: a liner opposite two adjacent metallic layers (for example, 3a1 and 3a2 in FIG. 17) may be sufficient.

In this case, the pot may be manufactured as follows to increase expected effectiveness and reliability:
a recessed shape is placed on substrate 31 so that it then creates bottom 30 and side wall 300 on the periphery of the bottom,
and either:
   electrical resistance 9 is incorporated into this substrate when the recessed form is produced, or
   either before or after stage a), such a resistance is placed between two electrically conductive metallic layers such as 3a1 and 3a2 which the substrate then includes, then this resistance is incorporated into the substrate
and said resistance 9 is connected to electric power source 7 with which cooking pot 30 is therefore equipped.

It is therefore recommended that resistance 9 be incorporated into substrate 31 by creating said two metallic electrically conductive layers between them, without adhesive, using deformation and/or a metallic chemical-physical bond.

In this description, “metallic” means a metal or metal alloy.

FIGS. 17 and 18 each show an alternative to the diagrams in FIGS. 2-4.

Electrical resistance 9 is still located on side wall 300.

However, it is now incorporated into said substrate, within:
either a cast electrically conductive metallic material (FIG. 18), or
multiple electrically conductive metallic layers bonded, without adhesive, by deformation and/or metallic chemical-physical bonding (FIG. 17).

In these cases, to reliably and safely manufacture the bowl so the resistance continues to operate over time, the use of resistance 9 surrounded by electrical insulation sheathing or layer 3c is recommended. Metallic material 3a1 (FIG. 18) or metallic layers 3a1 and 3a2 (FIG. 17) which surround it are electrically conductive, as recommended previously in FIGS. 2-4.

In FIG. 17, it may be made of colaminate. Electrical resistance 9 is incorporated into a metallic composite with two electrically conductive layers 3a1 and 3a2. On the interior side, the colaminate includes on the interior, against layer 3a1, third electrically conductive metallic layer 3a3 which may be coated on the inside with anti-stick coating 3b described above. Therefore, in the substrate, from internal layer 3a1 toward the outside and, therefore, in direct contact in pairs successively appear: Stainless steel or aluminum/aluminum/insulation/resistance/insulation/ferrite stainless steel.

In FIG. 18, electrical resistance 9 is incorporated into cast metallic material 3a1. This single material fully surrounds it. Substrate 31 may aluminum, or even cast iron. On the inside, this substrate may be coated with anti-stick coating 3b described above.

Layer 3b may be applied prior to or after substrate deformation.

It should be noted that, in general, it is possible that, in connection with the pressure formation of side wall 300 and the placement of resistance 9, bottom 3 should, therefore, be reinforced prior to or thereafter, by adding an insert such as 19 (FIG. 6) and/or stamps, such as 17 and 170 in FIGS. 5, 6.

FIG. 19 shows a close-up view from above of the bowl, with electric current moving in the substrate. To do so, an extremity of resistance 9 is electrically insulated; the opposite extremity is not insulated.

In FIG. 20, terminal 25b of handle 5 (the lower one) is in contact with primary extremity 25a of resistance 9 which is electrically insulated from the metallic bowl substrate, while the facing extremity of this resistance is not electrically insulated from said conductive substrate. Other terminal 25b (the upper one) of handle 5 is in contact with the conductive metal (substrate) of the bowl which then forms secondary terminal 25a (here, the upper one). This contact may be located, inter alia, near the ridge of upper edge 303 (here edge 305). Therefore, energy electrical will pass through the conductive substrate.

In FIGS. 21 and 22, we see respectively:
a drawing of heating pathway 9 (probably created by deposit, such as silk-screening) including multiple independent resistances, such as 9a1 and 9a2 (the resistance values of which may be different),
a drawing of a heating pathway, here including two resistances 9a1 and 9a2 (the values of which may be different: R1 and R2). In this case, the resistances appear in series: Rtot=R1+R2.

The position of handle 5 attached to the bowl (here with vertical contacts) allows heating location and power to be selected: the further one moves away from the U formed here (see the diagram), the greater the heated zone and electrical power.

Accordingly, lateral resistance 9, in particular on a deposited heating pathway, may include multiple resistances. In the first case, these resistances are independent, i.e., there are separate connections terminals. In the second case, they are interconnected and may be heated simultaneously.

To recharge electrical source 7, there is a rechargeable battery, preferably electromagnetic connection mechanism 60 accessible from the outside of removable handle 5.

This mechanism 60 may include “jack” type female socket 61 as shown in FIG. 23.

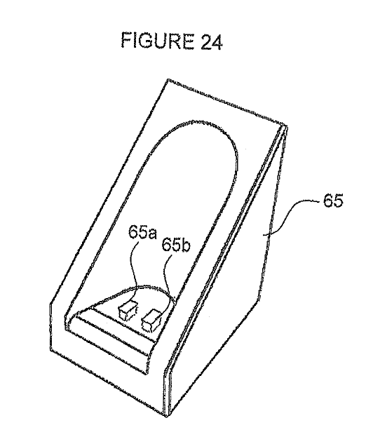

This socket is located on grip body 29. It can be connected to the electricity grid using a power cord with a “jack” type male plug. As shown in this FIG. 23, electromagnetic connection mechanism 60 may include two electrical connection terminals 63a and 63b which can be connected to and removed from two additional electrical connection terminals 65a and 65b on recharging stand 67 connected to the electricity grid and shown in FIG. 24 to recharge electrical source 7.

In one variation as shown in FIG. 25, electromagnetic connection mechanism 60 may include secondary induction coil 69 connected to electrical source 7. Secondary coil 69 is designed to receive the electromagnetic flow generated by primary induction coil 71 on recharging stand 73.

Grip body 29 includes a cavity opening to its external surface. Cavity 75 is surrounded by secondary induction coil 69 which is housed within grip body 29. The energy is transferred from the primary induction coil to secondary 69 without them coming into contact. These magnetic connection means ensure that grip body 7 is watertight and forms a watertight connection.

As already seen, rather than on a handle, electrical source 7 could therefore be generally located, for example, on a cover.

It is then possible that, in a cover placed on outside edge 303, the terminal contacts (such as 25b), with which it would be equipped along with terminal contact(s) 25a of the pot, could combine the heating of side wall 300 with simmering food placed in the bowl by low heating of the bottom by source 15.

It should also be noted from the foregoing that the bottom of the pot will not have a coil or an electrical resistance.

1. Cooking pot (1) which includes:
a pot designed to hold food which includes substrate (31) with bottom (30) and side wall (300) on the periphery of bottom (30), and heating electrical resistance (9) near side wall (300) of the pot,
electricity source (7) connected to electrical resistance (9) for electrical power, in which substrate (31) is metallic and electrical resistance (9) is located:
either on the outside of the substrate, or
incorporated into said substrate, within:
either cast electrically conductive metallic material (3a1), or
several electrically conductive metallic layers (3a1, 3a2, 3a3, 3a4, and 3a5), interconnected without adhesive by deformation and/or a chemical-physical metallic bond.

2. Cooking pot (1) in accordance with claim 1, in which bottom (30) has lower surface (14) facing external heat source (15) which is one of: an electrical plate, flame from a gas source, or induction coil (69 and 71) for induction heating of the pot and is designed to resist heat from said external heat source (15) and which, to do so, includes:
multilayered substrate structure (31) made of different metals or metal alloys (3a1, 3a2, 3a3, 3a4, and 3a5), and/or
at least:
one stiffness stamp (17 and 170), or
one insert (19) made of magnetizable metal which is attached to a malleable metallic layer of the substrate and/or which is harder than this malleable layer.

3. Cooking pot (1) in accordance with claim 1, in which electrical resistance (9) is located solely near side wall (300) of the pot, and bottom (30), which has lower surface (14) placed opposite external heat source (15) includes one of: an electrical plate, flame from a gas source, or induction coil (69, 71) for induction heating of the pot, is designed to resist heat from said external heat source (15) and, to do so, includes:
multilayered substrate structure (31) made of different metals or metal alloys (3a1, 3a2, 3a3, 3a4, and 3a5), and/or
and/or at least:
one stiffness stamp (17 and 170), or
one insert (19) made of magnetizable metal which is attached to a malleable metallic layer of the substrate and/or which is harder than this malleable layer.

4. Cooking pot (1) in accordance with claim 1, in which electrical resistance (9), which is located solely near side wall (300) of the pot, is incorporated into the metallic substrate where it is surrounded by electrical insulation layer (3c) which separates it from said metallic material (3a) or said metallic layers (3a1, 3a2, 3a3, 3a4, and 3a5) which surround it and are electrically conductive.

5. Cooking pot in accordance with claim 1, in which side wall (300) has internal surface (13) facing interior recess of substrate (31) and opposite outside surface (30a2), electrical resistance (9) heating is deposited at location (300) of the outside surface of the lateral wall, to electrical insulation layer (3c) which is itself deposited on the metallic substrate.

6. Cooking pot in accordance with claim 1, in which power source (7) is located on a cooking utensil, which is an accessory of the pot, such as a handle or cover.

7. Cooking pot in accordance with claim 6, in which the cooking utensil is handle (5) attached to the pot to raise it and thereby hold pot (1) by hand.

8. Cooking pot in accordance with claim 6, in which:
cooking utensil (5) may be removed from the pot using attachment mechanism (21a and 21b) which can be separated from one another, and
electrical resistance (9) and cooking utensil (5) have primary and secondary electrical contact terminals (25a and 25b) which come into contact with one another when cooking utensil (5) and the pot are attached to one another.

9. Cooking pot in accordance with claim 7, in which attachment mechanism (21a and 21b) include both bits (210a and 210b) which form a pincer and which move separately from one another to attach handle (5) to the pot, where said secondary electrical contact terminals (25b) are located on an at least one of these bits (210a and 210b).

10. Cooking pot in accordance with claim 8, in which secondary terminal(s) (25b) of handle (5) is(are) pushed by elastic recall mechanism (27) to limit contact resistance (9) to less than 100 mOmhs, and preferably to less than 10 mOmhs.

11. Cooking pot in accordance with claim 8, in which:
initial terminals (25a) are recessed, and
secondary terminals (25b) of cooking utensil (5) protrude and are used with elastic recall mechanism (27).

12. Cooking pot in accordance with claim 6, in which cooking utensil (5) includes:
recessed body (29),
rechargeable electrical energy source (7), such as a battery, housed in said body (29) which determines the shape of said electrical energy source (7), and
recharging terminals (25a and 25b) body (29) with which body (29) is equipped which are connected to rechargeable electrical energy source (7), and
watertightness means (43) to protect said rechargeable source (7) against humidity.

13. Cooking pot in accordance with claim 1, in which resistance (9) includes multiple resistances (9a1 and 9a2), which are independent or interconnected.

14. Cooking pot in accordance with claim 1, in which electrical resistance (9) is attached to pot (3) by depositing.

15. Cooking pot in accordance with claim 14, in which electrical resistance (9) is created by depositing silkscreened pathways with at least one electrically conductive material.

16. Procedure for manufacture cooking pot (1) with a pot which includes substrate (31) designed to hold food on its internal surface (13), in which the procedure includes a recessed substrate placement phase so that it then has bottom (30) and side wall (300) on the periphery of the bottom, in which substrate (31) has at least one metallic layer (3a1, 3a2, 3a3, 3a4, and 3a5) and, prior to or after the recess formation stage, heating electrical resistance (9) is attached near side wall (300), on external periphery (30a1) of metallic layer(s) (3a1, 3a2, 3a3, 3a4, and 3a5) of this side wall (300) and said resistance (9) is connected to electrical power source (7) on the cooking pot.

17. Procedure to manufacture cooking pot (1) with an pot which includes substrate (31) to hold food on internal surface (13), wherein the procedure includes a stage where the substrate is formed into a recess so that it has bottom (30) and side wall (300) on the periphery of the bottom, in which substrate (31) has at least one metallic layer (3a1, 3a2, 3a3, 3a4, and 3a5), and either:
heating electrical resistance (9) is incorporated into this substrate (31) when the recess is formed, or
prior to or after the recess formation phase, said resistance (9) is placed between said two electrically conductive metallic layers (3a1 and 3a2) which the substrate then contains, and this resistance (9) is incorporated into that substrate,
and said resistance (9) is connected to electrical energy source (7) with which the cooking pot is equipped.

18. Procedure in accordance with claim 17, in which resistance (9) is incorporated into the substrate by bonding said two electrically conductive metallic layers (3a1 and 3a2), without an adhesive, by deformation and/or chemical-physical metallic bond.

19. Procedure in accordance with claim 16, in which electrical resistance (9) is placed solely near side wall (300) of the pot, and bottom (30) and includes:
multilayered substrate structure (31) made of different metals or metal alloys (3a1, 3a2, 3a3, 3a4, and 3a5), and/or
at least:
one stiffness stamp (17 and 170), or
one insert (19) made of magnetizable metal which is attached to a malleable metallic layer of the substrate and/or which is harder than this malleable layer.
so that this bottom present has lower surface (14) facing external heat source (15) to be heated by one of: an electrical plate, flame from a gas source, or induction coil (69, 71) for induction heating of the pot by resisting the heat from said external heat source (15).

20. Procedure in accordance with claim 16, in which electrical resistance (9) is deposited
